(19) United States
(12) Patent Application Publication
(10) Pub. No.: US 2016/0240899 A1
(43) Pub. Date: Aug. 18, 2016

(54) TEMPERATURE CONTROL DEVICE FOR ELECTROCHEMICAL POWER SOURCE

(71) Applicant: GENTHERM AUTOMOTIVE SYSTEMS (CHINA) LTD., Langfang Hebei Prov. (CN)

(72) Inventors: Felix Fries, Shanghai (CN); Yu Zhang, Tianjin (CN); Fubing Peng, Hebei (CN); Dali Zhang, Hebei (CN); Jianming Liu, Hebei (CN)

(73) Assignee: GENTHERM AUTOMOTIVE SYSTEMS (CHINA) LTD., Langfang Hebei Prov. (CN)

(21) Appl. No.: 15/023,812

(22) PCT Filed: Oct. 31, 2014
(86) PCT No.: PCT/CN2014/089976

§ 371 Date: Mar. 22, 2016

(30) Foreign Application Priority Data
Nov. 1, 2013 (CN) 201310532631.3

(51) Int. Cl. H01M 10/63; H01M 10/625; H01M 10/6569; H01M 10/6572; H01M 10/6563

(52) U.S. Cl. CPC H01M 10/63; H01M 10/6572; H01M 10/6563; H01M 10/6569; H01M 10/625; H01M 2220/20

(57) ABSTRACT

The present invention relates to a temperature control device (1) for an electric power source (2). It is provided for the power source (2) to comprise a housing (4) and a plurality of elementary cells (3).

### BACKGROUND OF THE INVENTION

The present invention relates to a temperature control device for an electrochemical power source, in particular according to the preamble of claim 1. A typical area of application thereof is the heating or cooling of batteries, rechargeable batteries or fuel cells of vehicles and stationary loads.

### PRIOR ART

It is well known that electrochemical power sources provide little or no power below a certain minimum temperature. This is why some batteries are provided with heating mats, thus increasing the temperature of the battery by means of electric heating elements. However, the influence of such heating elements is often unsatisfactory when compared to the energy expenditure.

It is also known that electrochemical power sources can overheat, if large amounts of power are retrieved during operation in high ambient temperatures. In this context, it is well known to cool batteries by means of fans. However, depending on the application, this is not effective to the required extent.

It is thus desirable to provide a power supply which is less sensitive to temperature variations.

### SUBJECT MATTER OF THE INVENTION

In view of this, a technical concept is suggested having the features of claim 1. Further advantageous embodiments can be derived from the further claims and the following description.

### FIGURES

Details of the invention will be explained in the following description and claims. These explanations are for the further illustration of the invention. However, they only are of exemplary character. Of course, individual or several of the features described may also be omitted, modified or supplemented within the scope of the invention as defined by the independent claims. The features of different embodiments may, of course, also be combined with each other. What is crucial is that the concept of the invention is essentially implemented. If a feature is to be at least partially fulfilled, this also includes that the relevant feature is completely or essentially fulfilled. “Essentially” means that the implementation allows the desired use to be achieved to a recognizable extent. This can mean, in particular, that a corresponding feature is fulfilled by at least 50%, 90%, 95% or 99%. If a minimum amount is indicated, more than the minimum amount can, of course, also be used. If the number of a component is indicated as being at least one, it also includes embodiments having two, three, or any other plurality of components. Features described for one object can also be applied to the greater part or the entirety of all other equivalent objects. If not otherwise indicated, intervals also include their end points. If several alternative options are indicated for the implementation of the invention, they can be implemented individually or simultaneously in combination with each other. In this case “or” thus means “either . . . or” and “and”.

In the following, reference will be made to the drawing figures, wherein:

FIG. 1 shows an automotive vehicle with an electrochemical power source in partial longitudinal section; and

FIG. 2 shows an electrochemical power source of FIG. 1 in an exploded view.

### DESCRIPTION OF THE INVENTION

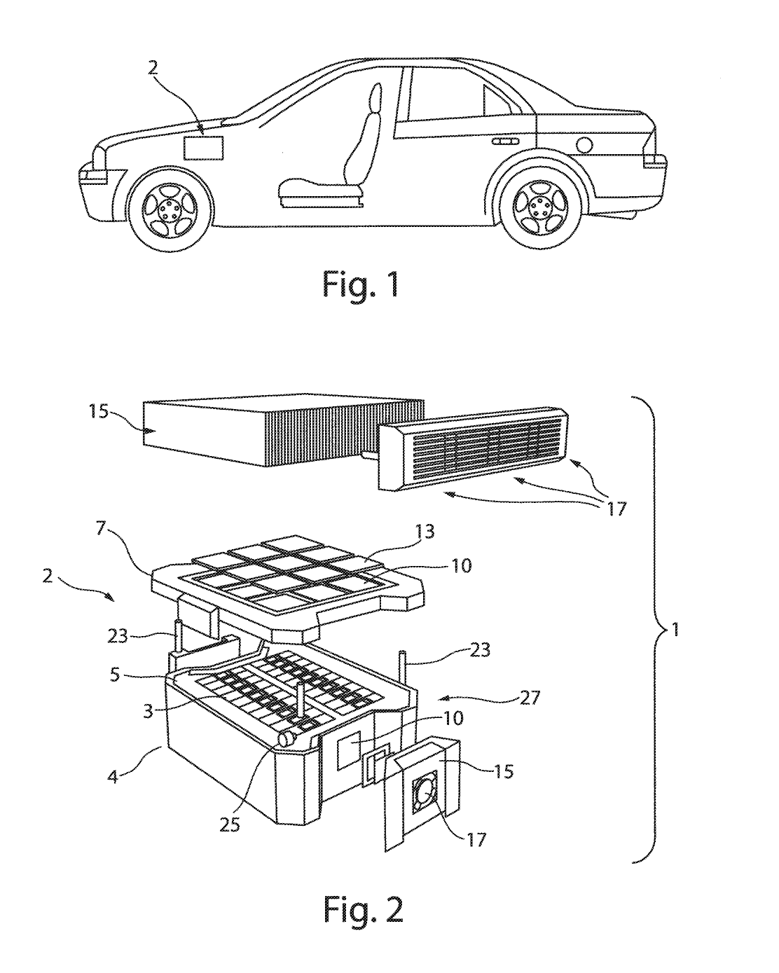

The present invention can be utilized, for example, in a vehicle according to FIG. 1. The vehicle means a device for the transportation of people, and/or goods, such as land vehicles, water craft, rail vehicles and aircraft, in particular planes, ships, and automotive vehicles.

Such a vehicle or craft can be equipped with an electrochemical power source according to the present invention.

The electrochemical power source is, for example, a non-rechargeable battery, a rechargeable battery or a fuel cell. It serves to supply power to various electrical consumers in the vehicle, such as an electric drive motor, a starter motor, lighting, or the like. A vehicle can be provided with one or more such power sources. Such a power source 2 is preferably provided at a position which is exposed or can be made accessible to the air current during driving or the ambient air, such as in an engine compartment, underneath a vehicle chassis or in the luggage compartment.

An electrochemical power source 2 preferably includes a plurality of elementary cells 3. This means a module in terms of an assembly or an encapsulated unit having at least two electric terminals and a chemical energy store. They can be, for example, lead/lead oxide cells. Preferably, a plurality of elementary cells is provided in a power source so that, in combination, an electric potential of sufficient voltage, such as 12 V, 24 V, 48 V, 110 V or 230 V, is achieved. A combination may also be desirable to achieve amperage of sufficient magnitude. In the present exemplary embodiment, ten elementary cells are arranged in series and two such series are provided in juxtaposition in the power source. Elementary cells 3 preferably have a shape which allows them to be spatially tightly packed in order to achieve a high charge density of the power source. Cuboids or rods are suitable shapes for this purpose. At least one elementary cell is arranged within the power source. Preferably this applies to all elementary cells. Preferably, they are aligned in such a manner that they are easily contacted and temperature controlled. This can be achieved, in particular, by the vertical extension of the longitudinal axes, and by arranging the electrical terminals toward the top. Preferably, elementary cells are positioned relative to other elementary cells or a housing wall in such a manner that they are immovably supported during operation. Moreover, minimum clearances between the components ensure reliable flow of a temperature control fluid around them. Preferably, there is a minimum clearance of 3 mm, preferably 5 mm, preferably 1 cm, between at least one elementary cell and an adjacent elementary cell. The same also applies preferably to the minimum clearance between at least one elementary cell and at least one housing wall of the power source.

Preferably, a power source 2 has at least one housing 4. The term “housing” in the present context means a device for preventing undesirable leakage of chemicals or unintended contacting of electrical components of the power source. Preferably, it is a gas- or liquid-tight container, in particular, a basin- or cuboid-shaped hollow body. The shape of the housing essentially follows the contour of the groups of elementary cells arranged therein. The housing is preferably of a material which allows for efficient temperature control of the contents of the power source, as well as a light and rugged structure. These are, for example, plastic materials, in particular with acid-resistant and thermally conductive compositions, aluminum or carbon- or glass-fiber-reinforced composites. A housing is particularly preferred which has a wall at least partially consisting of aluminum. If required, it can be locally coated in order to achieve thermal, chemical or electric shielding or insulation of the aluminum.

The housing preferably comprises a cover 7. The cover 7 preferably essentially has the contour of the base area of the power source 2. Preferably, it is fixed on the housing 4 in both a liquid- and a gastight manner. The cover is preferably of the same material or the same materials as the remainder of the housing 7.

Preferably, the power source comprises a temperature control fluid 5. It has the function of enabling dissipation of excess heat from the elementary cells to the housing of the power source, or transfer of heat from the housing of the power source to the elementary cells, in case their temperature is too low. The term “temperature control fluid” is used as meaning a shapeless body, which can store, transport and give off heat at a suitable position. Examples are liquids, gases, granulates, powders or mixtures of one or more of these components. It is preferably present in the power source in an amount which enables uniform flow around all components of the power source. This achieves homogeneous temperature distribution without any excessively cold or hot zones. Preferably, the temperature control fluid fills the entire space available between the elementary cells and the housing.

The material of the temperature control fluid, at least in a liquid state, preferably has a thermal capacity allowing for efficient transport of heat. Suitable heat capacities for this purpose range from 1 kJ/(kg K), more preferably 1,1 and higher. Suitable materials are water, aqueous salt solutions, water-containing and water-free alcohols, fluoroketones, hydrofluoro hydrocarbons and other well-known heat carriers.

Preferably, at least parts of the temperature control fluid have an evaporation temperature of less than 100° C., preferably less than 70° C., preferably between 40 and 55° C. Preferably, the boiling point of the fluid is between the setpoint operating temperature of the power source and a value no more than 20% above the maximum desirable operating temperature, more preferably 10%. The percentages relate to the temperature values in Kelvin. Should any of the elementary cells 3 overheat locally, the temperature control fluid would evaporate. Evaporation of the temperature control fluid would counteract overheating in two ways. On the one hand, the phase change from the liquid to the vapor phase leads to an increase in heat absorption by the temperature control fluid. In addition, the vapor would quickly rise up within the power source due to its lift. In this way, on the other hand, excess heat transported is particularly rapidly to the housing wall and, at the same time, space is made for inflowing liquid temperature control fluid in the hot zone. This effect is particularly easily achieved with fluoro hydrocarbons and fluorine-containing ketones. Otherwise, the temperature control fluid should be non-toxic, non-flammable and ozone neutral. Preferably, it is chemically stable only for a few days or weeks when in contact with air.

Preferably, the housing has one or more heat passages 10. Preferably, a plurality of heat passages is provided in the cover 7 of the housing 4. This is because, due to convection of the temperature control fluid 5, hot fluid will tend to move upwards towards the cover. Preferably, the ends and sides of the housing are also provided with heat passages. Additional heat passages at the bottom of the housing can be useful, in particular, for the introduction of heat into the power source, since due to the resulting convective movement of the temperature control fluid, it can excellently distribute heat within the power source as it rises along the elementary cells within the power source.

At least one heat passage comprises a thermally conductive layer, which is part of the wall of the housing 4. An insulating layer of the housing 4, if provided, is interrupted in the area of the heat passage, so that a recess is present in this area.

The temperature control device 1 preferably comprises at least one thermoelectric element 13. A thermoelectric element is a component which, upon the application of electric voltage, has at least one surface with an increased temperature, and at least one surface with a reduced temperature when compared with a state without the application of voltage (Peltier element), and components which generate an electric potential upon the application of a temperature gradient (Seebeck element). Such thermoelectric elements are preferably flat, essentially ceramic components whose base area preferably corresponds to the area of the heat passages 10. Preferably, at least 50% of the base area of the cover is occupied by thermoelectric elements. Preferably, at least one heat passage 10 per end surface is equipped with at least one thermoelectric element.

In order to improve the efficiency of the heat transfer, the temperature control device is provided with at least one heat transfer device 15. The heat transfer device 15 on the one hand enables better heat transfer between the surface of the thermal elements and air outside of the power source 2 by increasing the available interface between the air and the temperature control device. On the other hand, it allows the air throughput to be increased. Both objectives can be achieved by the heat transfer device 15 comprising at least one heat conduction body having a plurality of heat conduction fins extending parallel with respect to each other. Preferably, the heat conduction body also comprises a thermally conductive material, such as a metal, like aluminum or copper. Preferably, the heat transfer device 15 is associated with at least one air mover 17. The air mover 17 can be one or more fans arranged, for example, at the end face of the heat conduction body, to convey air along the heat conduction fins through the heat transfer device 15. In this way, excess heat is removed from the heat transfer device 15 and the heat conduction fins by means of the air blown through it, or heat is absorbed from the air blown in by means of the heat conduction fins for introduction into the power source 2. At least one air mover 17 can also be provided having a sucked-in or blown-out air flow which at least on entering or leaving the air mover has a flow direction directed along a normal line to the base area of the thermoelectric element and/or a heat passage 10. In particular, an axial fan can be provided to blow an air flow onto a thermoelectric device and/or a heat passage 10. A flow reversal may also be provided in order to temperature control a heat passage 10 and/or a thermoelectric element by means of a radial air flow and to have the exhaust air expelled normal to the base area of the heat outlet or the thermoelectric element by means of the axial fan. To achieve this, it may be suitable to arrange the air mover 17 not laterally at an end face of the heat transfer device 15, but centrally and in a manner at least partially replacing the heat conduction fins of the heat conduction body within the heat transfer device 15. The air mover 17 can be provided with a cover 19 to prevent inadvertent interference with rotating impellers, to protect the air movers against fouling or foreign bodies, and to guide incoming or outgoing air in a preferred direction.

To ensure heating of the power source 2 also with extremely low temperatures or with short reaction times, the temperature control device can be provided with one or more additional heaters 23. They can be planar heating elements arranged in side faces of the housing 4. However, at least one additional heater 23 can also be arranged in the form of a heating rod within the temperature control fluid 5. Since the housing 4 cools down fastest from the corners, it is suitable to arrange additional heaters in these areas, in particular. For this purpose, the housing 4 preferably comprises vertically aligned bulges to receive the additional heater 23, also vertically arranged, and a partial reservoir of the temperature control fluid. Preferably, these bulges are arranged at the end face of the power source 2 in order to achieve a compact shape. Suitably, at least one heat passage and one heat transfer device 15 are arranged between two such bulges of each end face.

At least one additional heater 23 is preferably made of a PTC (positive temperature coefficient) material or a ceramic material (e.g. MCH).

To ensure homogeneous temperature control of the elementary cells 3 within the power source 2, the temperature control device can also be provided with a fluid mover 25. This can be, for example, a turbine having its own electric drive within the housing 4. To ensure protection against aggressive media, it can also be an impeller with magnetic or magnetizable components, which is able to be set into motion by a drive mechanism arranged outside of the housing 4 by means of magnetic fields. Preferably, the fluid mover 25 is provided in or near the bulges 27 to ensure reliable flow around the additional heaters 23 and to avoid local overheating of the temperature control fluid 5.

Making the housing 4 gastight prevents air moisture from entering. The overhead for air-cooled systems hitherto necessary in this respect can be omitted. The system is still protected against corrosion and electrical shorts due to moisture condensation. To avoid problems due to excess pressure with thin-walled housings, it may be suitable to fill the interior of the housing 4 with two different substances. The first substance functions as the actual temperature control fluid. It has the properties already described with reference to thermal capacity and evaporation behavior. The second substance is preferably gaseous at all operating temperatures of the power source. This applies, in particular, to a temperature range from −50 to +100° C., preferably −30 to +60° C. Preferably, the second substance does not, or only insignificantly, dissolve in the first substance. The second substance preferably comprises gaseous nitrogen (N₂), carbon dioxide (CO₂) or waterless air. Preferably, the second substance is from 1 to 70%, preferably between 10 and 50%, in particular between 10 and 30% of the overall volume of the two substances.

If a gas reservoir is formed beneath the cover 7, which includes condensable components of the temperature control fluid, the temperature control device 1, at the cover, functions like a condenser. This is because the evaporated temperature control fluid is cooled down at the cover at the heat passage 10 until it reaches its condensation temperature. The temperature control fluid then precipitates as a liquid and drips into the liquid reservoir in the housing 4.

### LIST OF REFERENCE NUMERALS

1 temperature control device

2 power source

3 elementary cell

4 housing

5 temperature control fluid

7 cover

10 heat passage

13 thermoelectric element

15 heat transfer device

17 air mover

23 additional heater

25 fluid mover

27 bulge

1. A temperature control device for an electric power source comprising:
a housing, and
a plurality of elementary cells,
wherein:
a temperature control fluid provided within the housing and surrounding the plurality of elementary cells,
at least one device for influencing a temperature of the temperature control fluid.

2. The temperature control device according to claim 1, wherein the at least one device for influencing the temperature of the temperature control fluid comprises at least one of the following components:
a thermoelectric element, an additional heater, a heat transfer device, or an air mover.

3. The temperature control device according to claim 1, wherein the temperature control fluid has an evaporating temperature at normal pressure of less than 100° C.

4. The temperature control device according to claim 1, wherein the housing has at least one cover, which is provided with at least one device for influencing the temperature of the temperature control fluid.

5. The temperature control device according to claim 1, wherein the temperature control fluid has an evaporating temperature at normal pressure of below 70° C.
